(19) United States
(12) Patent Application Publication
(10) Pub. No.: US 2024/0419393 A1
(43) Pub. Date: Dec. 19, 2024

(54) VEHICLE AUDIO OUTPUTS

(71) Applicant: Tesla, Inc., Austin, TX (US)

(72) Inventors: Evan Small, Palo Alto, CA (US); Saubhagya Rathi, Palo Alto, CA (US); Shammi Mohamed, Palo Alto, CA (US); Charles Shieh, Palo Alto, CA (US)

(21) Appl. No.: 18/701,759

(22) PCT Filed: Oct. 20, 2022
(86) PCT No.: PCT/US2022/047304

§ 371 Date: Apr. 16, 2024

Related U.S. Application Data
(60) Provisional application No. 63/271,483, filed on Oct. 25, 2021.

(51) Int. Cl. G06F 3/16; H04N 21/414; H04N 21/43; H04N 21/485

(52) U.S. Cl. CPC G06F 3/165; H04N 21/41422; H04N 21/4307; H04N 21/4852

(57) ABSTRACT

Aspects of the present application incorporate the management of vehicle media outputs corresponding to external speaker systems. Illustratively, a vehicle can be configured with a set of speakers that are configured primarily to generate audio outputs to the interior cabin of a vehicle, generally referred to as internal speakers. Additionally, a vehicle can be further configured with one or more speakers that are configured figured primary to generate audio outputs to the exterior of the vehicle, generally referred to as external speakers. One or more aspects of the present application correspond to management of actions that facilitate different embodiments for integrating the external speakers as part of media generation.

### CROSS-REFERENCE TO RELATED APPLICATION

This application is a non-provisional of and claims priority to U.S. Provisional Patent Application No. 63/271,483, entitled “VEHICLE AUDIO OUTPUTS,” filed on Oct. 25, 2021, which is hereby incorporated by reference in its entirety and for all purposes.

### BACKGROUND

Generally described, a variety of vehicles, such as electric vehicles, combustion engine vehicles, hybrid vehicles, etc., can be configured with various components. In certain scenarios, such vehicles may be configured with various media components that facilitate the generation of audio and video media content by the vehicle. For example, a vehicle may be provided access to audio media that can be rendered through by a media playing application through the internal speakers in the vehicle.

Illustratively, computing devices and communication networks can be utilized to exchange data and/or information. In a common application, a computing device can request or transmit content from another computing device via the communication network. For example, a user at a mobile computing device can utilize an application to requestor or transmit content to a vehicle. In another embodiment, media content can be made accessible to one or more applications on a computing device via a communication network.

### BRIEF DESCRIPTION OF THE DRAWINGS

This disclosure is described herein with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1A depicts a block diagram of an illustrative environment for providing vehicle communication with a network service in accordance with one or more aspects of the present application;

FIG. 1B depicts a block diagram of an illustrative architecture of a vehicle implementing a management component in accordance with aspects of the present application;

FIG. 2 is a block diagram of the illustrative environment of FIG. 1A illustrating interactions between a user and the management component to configure the playback of media in accordance with aspects of the present application;

FIG. 3 is a block diagram of the illustrative environment of FIG. 1A illustrating interactions between a user and the management component to configure the playback of media according to vehicle operational parameters in accordance with aspects of the present application;

FIG. 4 is a flow chart describing a routine for management of an external speaker in a vehicle in accordance with aspects of the present application; and

FIG. 5 is a flow chart describing a routine for management of an external speaker in a vehicle in accordance with aspects of the present application.

### DETAILED DESCRIPTION

Generally described, one or more aspects of the present disclosure relates to the configuration and management of actions implemented by vehicles. By way of an illustrative example, aspects of the present application incorporate the management of vehicle media outputs corresponding to external speaker systems. Illustratively, a vehicle can be configured with a set of speakers that are configured primarily to generate audio outputs to the interior cabin of a vehicle, generally referred to as internal speakers. Additionally, a vehicle can be further configured with one or more speakers that are configured primarily to generate audio outputs to the exterior of the vehicle, generally referred to as external speakers. One or more aspects of the present application correspond to the management of actions that facilitate different embodiments for integrating the external speakers as part of media generation.

Generally described, vehicles have been configured with some form of external audio generation component, such as air horns. In the context of electric vehicles, the electric motor typically does not generate any form of sound as part of the delivery of power to the vehicle. Accordingly, some electric vehicles have been configured with additional externally oriented sound generation devices that emit various sounds that are configured to alert pedestrians regarding the presence of the electric vehicles. For example, electric vehicles may be configured with a speaker that is configured to emit emulated combustion engine sounds or audible tones that are intended for pedestrians to be cognizant of the presence of the electric vehicle (e.g., safety sounds). Specifically, the sounds generated by the electric vehicle are often selected to correspond to sounds generated by non-electric vehicles.

In such embodiments, the external speaker system is limited to a dedicated safety component and is separate from any internal media generation components, such as a media player. Such external speakers are typically not accessible by any other vehicle systems other than the dedicated safety component or is not otherwise configured for generating outputs other than the intended safety sounds. Still further, in such typical embodiments, the external audio generation components are not configurable to exchange information or otherwise be integrated with other audio generation components, such as additional external stand-alone speakers, external audio generation components of other vehicles, and the like.

To address at least a portion of the above-identified inefficiencies, one or more aspects of the present application correspond to a media management system and associated component(s) for the generation of media content in vehicles. Illustratively, in one embodiment, a vehicle is configured with an internal audio component, such as a set of audio speakers configured to generate audio sounds to passengers within the interior cabin of the vehicle. The internal audio component is provided audio signals via an internal speaker media application and associated hardware components. The vehicle is also configured with an external audio component, such as one or more audio speakers configured to generate audio sounds external to the vehicle. The external audio component is provided audio signals via an external speaker media application and associated hardware components.

Illustratively, both the internal speaker media application and the external speaker media application can access media maintained locally within the vehicle, media provided via short range wireless connection, such as mobile device or other vehicles, or media provided via a network connection. In accordance with aspects of the present application, the generation/playback of media via the external audio component may be further synchronized with other media applications, including the internal speaker media application, other internal/external media applications associated with other vehicles, additional external media devices, and the like. In accordance with other aspects of the present application, the generation/playback of media via the external audio component may be further configured with movement media profiles that facilitate the generation of media sounds in accordance with vehicle operational parameters. For example, the generation of media via the external audio component may be configured so that a vehicle can play selected media (e.g., a song) in which the attributes of the playback are dependent on vehicle operational parameters, such as vehicle speed or speed thresholds, geographic location, the specified function of the vehicle, and the like. In still another example, the generation/playback of media may be configured so that a vehicle can play selected media (e.g., sound clips) based on the operational status of the vehicle or vehicles, such as status indicators associated with the vehicle (e.g., door lock status, passenger detection, etc.).

Although the various aspects will be described in accordance with illustrative embodiments and a combination of features, one skilled in the relevant art will appreciate that the examples and combination of features are illustrative in nature and should not be construed as limiting. More specifically, aspects of the present application may be applicable with various types of media, vehicles, or vehicle processes. For example, although illustrative examples in accordance with aspects of the present application will be described with the generation of audible sounds, other types of outputs may also be generated. Accordingly, one skilled in the relevant art will appreciate that the aspects of the present application are not necessarily limited to application to any particular type of media or illustrative interactions. Additionally, aspects of the present application may be applicable with regard to the playback or reproduction of media content. Additionally, aspects of the present application may also be applicable with regard to the generation of media content, such as via additional software or hardware functionality (e.g., user interfaces). Accordingly, reference to playback or generation of media is not intended to be limited solely to any particular implementation. All such interactions described herein should not be construed as limiting.

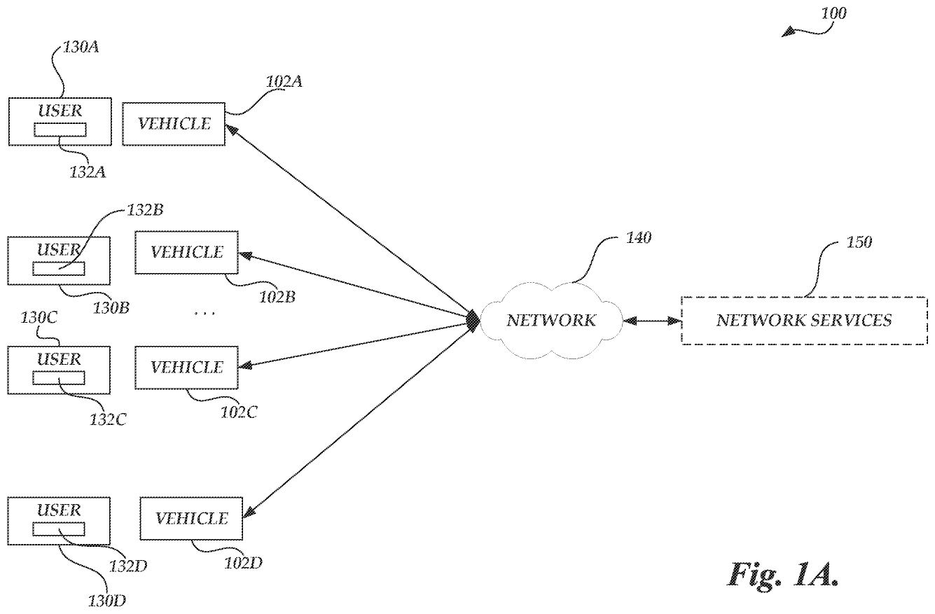

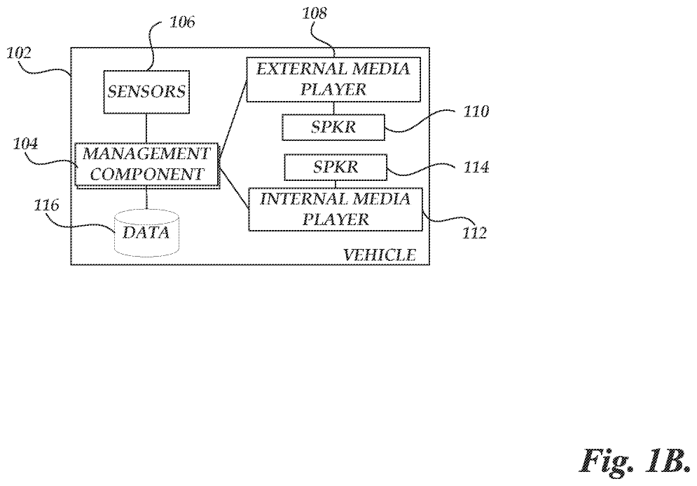

FIG. 1A illustrates an environment 100 in a plurality of vehicles 102A, 102B, 102C, 102D that may be configured for the generation of media via the external audio component in accordance with one or more aspects of the present application. FIG. 1B illustrates individual components/architecture of a vehicle 102, such as the vehicles 102A, 102B, 102C, 102D, as illustrated in FIG. 1A.

With reference to FIG. 1B, a individual vehicle 102 includes a management component 104 that facilitates functionality associated with the vehicles 102. The management component 104 can illustratively include communication functionality, including hardware and software, that facilitate interaction via one of a plurality of communication mediums and communication protocols. Additionally, the management component 104 can implement various types of executable code or commands to implement various functionality, including configuration of media playback/generation by one or more media players, configuration or collaboration of media playback between the vehicle 102 and other devices, such as other external audio generation components or other vehicles, execution of media playback profiles/configurations, and the like. The management component 104 may be implemented according to one or more processors, memory and other computing device resources associated with the execution of a management component. The management component 104 may also be implemented in accordance with specialized or dedicated processing components. Still, further, the management component 104 may, in other embodiments, be implemented in a set of processing components, such as in a distributed manner to implement various functionality associated with the management component 104. For example, the management component 104 can also be configured in some aspects to obtain and implement movement profiles (or media profiles) associated with the playback of media via the external speaker media application and the external speaker systems Such profiles may be stored in data stores 116.

Additionally, the vehicle 102 includes a plurality of sensors 106, components, and data stores 116 for obtaining, generating, and maintaining vehicle data, including operational data. In some embodiments, the information provided by the components can include processed information in which a controller, logic unit, processor, and the like has processed sensor information and generated additional information, such as a vision system that can utilize inputs from one or more camera sensors and provide outputs (e.g., a processing of raw camera image data and the generation of outputs corresponding to the processing of the raw camera image information). The camera sensor may be the sensor component that is associated with vision systems for determining vehicle operational status, environmental status, or other information. In other embodiments, the camera sensors can be separate from the sensor components, such as for non-camera sensor components or vehicles having multiple camera sensors. In still another example, the management component 104 can utilize additional information obtained from, or otherwise associated with, other sensors 106, such as positioning systems, calendaring systems, or time-based systems. Still, further, the sensors 106 can include sensors configured for vehicle operational parameters, such as speed sensors, passenger detection systems, transmission state detection systems, temperature sensors, HVAC sensors or state systems, and the like. One skilled in the relevant art will appreciate that sensors 106 can include various types of sensors or sensing systems and combinations of sensors or sensing systems. Accordingly, the above-described examples should be construed as limiting.

As shown in FIG. 1B, an individual vehicle 102 can illustratively include an internal speaker media application 112 that is configured to access an internal speaker system 114. The internal speaker system 114 may correspond to a plurality of media generation devices, such as speakers, that may be utilized in the playback of media. The internal speaker media application 112 can illustratively access media available for playback via local storage devices, devices physically connected to an interface within the vehicle, devices available via network connections, such as short-range wireless connections (e.g., Bluetooth connections) or Internet services, and the like. Individual vehicles 102 can illustratively include an external speaker media application 108 that is configured to access an external speaker system 110. The internal speaker system 110 may correspond to one or more media generation devices, such as speakers, that may be utilized in the playback of media. In some embodiments, the internal speaker system 114 and the external speaker system 110 can be physically separate such that no single media application (108 or 112) can access both the internal and external speaker systems 110, 114. The external speaker media application 112 can illustratively access media available for playback via local storage devices, devices physically connected to an interface within the vehicle, devices available via network connections, such as short-range radio communication channels or wireless connections (e.g., Bluetooth connections) or Internet services, and the like. The internal and external media applications 112, 108 may be accessed by a user via interfaces generated in the vehicle 102, mobile applications, and the like.

As illustrated in FIG. 1A, in some embodiments, users may be able to access or configure media playback via a mobile device 130 (e.g., 130A, 130B, 130C, and 130D) that includes a mobile application 132 (e.g., 132A, 132B, 132C, and 132D). Additionally, the network service(s) 150 illustratively corresponds to a one or more computing devices that are operable to host a network service for providing media for access by the internal media application, external media application and a combination thereof. In one aspect, a network service 150 may also be configured to provide movement profiles as described herein. For example, in accordance with a ride share or taxi service implementation, a network service 150 may be configured to provide movement profiles for one or more passengers that will participate in the ride share/taxi service (e.g., a custom media playback profile during pickup, travel, drop off, etc.). In another aspect, a network service 150 may be configured to provide information for coordinating the playback/generation of media between an individual vehicle and other vehicles or other external audio generation components, such as speaker systems. The present disclosure does not limit the number of vehicles.

Network 140, as depicted in FIG. 1A can connect to the vehicle 102 (such as devices, components, and/or modules of the vehicle). The network 140 can connect any number of vehicles. In some embodiments, the vehicle 102 and the network service 150 can communicate or exchange data (e.g., the establishment of one or more communication channels) via the network 140. In some embodiments, the network service 150 provides network-based services to the vehicle 102 via the network 140. The network service 150 can implement network-based services and refers to a large, shared pool of network-accessible computing resources (such as compute, storage, or networking resources, applications, or services), which may be virtualized or bare-metal. The network service 150 can provide on-demand network access to a shared pool of configurable computing resources that can be programmatically provisioned and released in response to customer commands. These resources can be dynamically provisioned and reconfigured to adjust to the variable load. The concept of “cloud computing” or “network-based computing” can thus be considered as both the applications delivered as services over the network and the hardware and software in the network service that provides those services.

In some embodiments, the network 140 can be secured networks, such as a local area network that communicates securely via the Internet with the network service 150. The network 140 may include any wired network, wireless network, or combination thereof. For example, the network 140 may be a personal area network, local area network, wide area network, over-the-air broadcast network (e.g., for radio or television), cable network, satellite network, cellular telephone network, or combination thereof. As a further example, the network 150 may be a publicly accessible network of linked networks, possibly operated by various distinct parties, such as the Internet. In some embodiments, the network 150 may be a private or semi-private network, such as a corporate or university intranet. The network 150 may include one or more wireless networks, such as a Global System for Mobile Communications (GSM) network, a Code Division Multiple Access (CDMA) network, a Long Term Evolution (LTE) network, a 5G (5 generation wireless communication), or any other type of wireless network. The network 140 can use protocols and components for communicating via the Internet or any of the other aforementioned types of networks. For example, the protocols used by the network 140 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

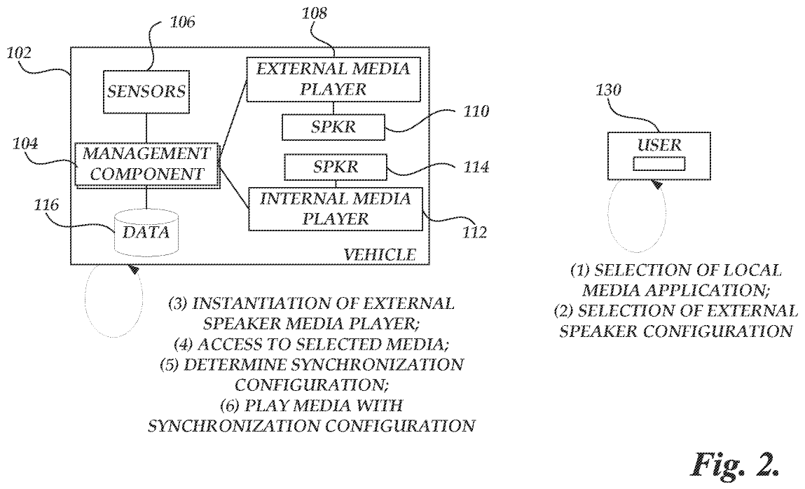

With reference now to FIG. 2, an illustrative interaction between a user via a mobile application 132 executed on a mobile device 130 and the management component 104 of the vehicle 102 to configure the playback of media will be described. Although a set of interactions are illustrated, the present application is not limited to any particular configuration of the playback of media. In this regard, actions attributable to a “user” may be considered to be in conjunction with interaction with computing devices, such as the mobile device 130.

At (1), the user selects a local media application for the playback of media (e.g., the generation of sound). Illustratively, a user may access a media application or control application 132 on a mobile device 130. The user can designate the media to be played and attributes of the playback, including audio levels, speed, effects, and the like. In other embodiments, the user may access interfaces generated within the vehicle 102, such as a touchscreen interface. In some embodiments, the selection of the local media application includes receipt of dynamically created media.

In some embodiments, the user input can select or designate media that is stored in a variety of locations, such as network-based storage, local storage on a device, local storage on the vehicle, peer devices, etc. In other embodiments, the user input can include the generation of content to be played or rendered by the vehicle 102. For example, a user may be provided with functionality via the vehicle display or mobile device in which audio input can be captured via input device (e.g., microphone), processed, and then provided as media for playback. In one embodiment, the capture of the audio input can correspond to a security/safety application in which the user content can be amplified, supplemented, or processed to notify bystanders of a safety issue, provide warnings to individual outside the vehicle, or a combination thereof. Additional external outputs, such as flashing of the headlights, etc., may also be selected. In another embodiment, the capture of audio input can correspond to music performance activities, such as singing (e.g., karaoke), playing of musical instruments, and the like.

In still other embodiments, the user can be presented with various situational input controls/objects in which a user can select a type of media without requiring the selection of a specific media file for playback. For example, a user can select a safety control or safety type that can result in the selection of predetermined sounds, audio tracks, etc., and associated attributes regarding playback. In another example, a user can select an emotional control or mood control that expresses a sentiment or desired result based on playback of media corresponding to the selected control. The user does not select media for playback but is electing to have specific media selected on behalf of the user. The selection can be dynamic so that the selected control may be a surprise to the user and may change, at least partially.

Additionally, at (2), the user can select the playback of the media (e.g., audio) via the internal speaker system 114 (via the internal media application 112), the external speaker system 110 (via the external media application 108), or a combination thereof. In some embodiments, the user who does not select a media player to generate the playback can simply designate the desired audio output systems, such as the internal speaker system 114, external speaker system 110, or a combination. The user selections may be transmitted to the management component via a network connection, such as via an application programming interface (API) from the mobile device to the vehicle 102. In other embodiments, a user may utilize audio inputs (e.g., a microphone) to provide audio commands interpreted by the management component 104.

For purposes of illustration, in illustrative embodiments, assume that the user input corresponds to at least the selection of media playback on the external media speaker 110 or the generation of live content for playback by the vehicle 102. At (3), the management component 104 instantiates external speaker media application 108. Illustratively, the playback of the selected media via the external speaker system is controlled by an instantiated external speaker media application 108 that is separate from any internal speaker media application 112 that controls playback on the internal speaker systems 114. The external speaker media application 108 may be instantiated at the selection of media for playback. In some embodiments, the external speaker media application 108 may be pre-instantiated, such as based on the previous playback, and the instantiation step may be omitted.

At (4), the instantiated external speaker media application 108 accesses the selected media, such as via direct access (e.g., physically connected media device or local media storage) or network access. In dynamic content that is selected and has not been previously captured, the external speaker media application 108 may interface with a mobile device or vehicle input device to capture the dynamic content (e.g., spoken words). For example, in one embodiment, the dynamic content can include a karaoke type functionality in which a user interface may present a user with graphics/displays with lyrics or other cues to elicit audio (e.g., singing). In another embodiment, the dynamic content can include music generation in which a user may interface with a traditional instrument (e g., a keyboard) or is presented with a user interface corresponding to a musical instrument or music generating application.

At (5), the management component 104 determines synchronization configuration. In some embodiments, the playback of media through the selected external speaker system may coordinate such that media playback may occur through the internal speaker system 114 as well. In one example, the internal speaker media application 112 and the external speaker media application 108 would then be synchronized as to the attributes of the playback (e.g., volume and playback speed) and timing (e.g., matching timing or offset). Each media application 108, 112 may continue to operate independently but can exchange information or be configured with information to facilitate concurrent playback. In another embodiment, multiple external speaker media applications 108 may also be synchronized such that a plurality of vehicles may implement a coordinated playback of media. Such coordination can include attributes of the playback, such as volume settings and timing. Additionally, the coordination can include the assignment of specific parts of the component to individual external speaker media application, such as for stereo effects, surround sound, etc. The vehicles 102 may each be configured with At (6), the external speaker media application generates the playback in accordance with the synchronization configuration.

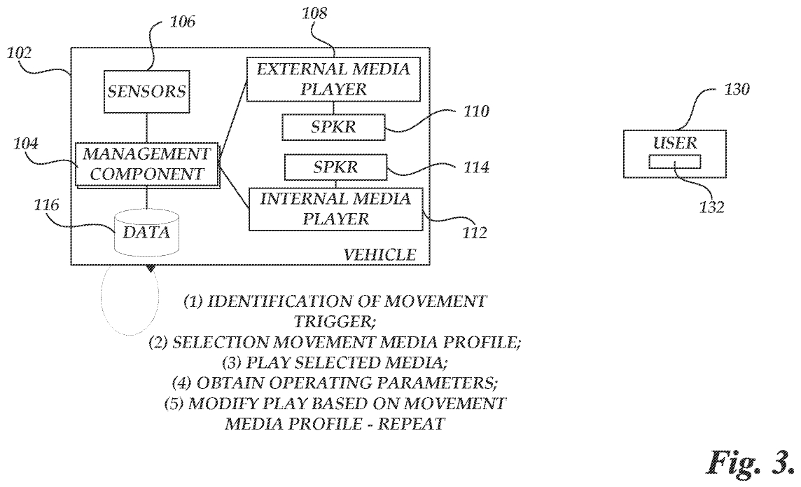

With reference now to FIG. 3, an illustrative functionality implemented by the management component 104 to configure the playback of media according to vehicle operational parameters will be described. At (1), the management component 104 determines a trigger to cause the generation of media playback during the operation of the vehicle. Illustratively, this can include a user-initiated selection, such as via an interface or mobile application 132 of a mobile device 130. In another example, the trigger may be based on geographic criteria (e.g., location of the vehicle), time criteria, environmental criteria (e.g., temperature), and the like.

At (2), the management component 104 selects a movement profile. Illustratively, a movement profile corresponds to a specification of media for playback and control instructions for attributes of the media playback that are illustratively tied to operational parameters of the vehicle 102. In one example, the movement profile can specify one or more vehicle speed thresholds that indicate timing for the start of playback or stop of playback. In another example, the movement profile can specify volume settings and adjustment as a function of operational parameters, such as speed, temperature, wind presence and strength, vision systems, and the like. In still another example, the movement profile can further include media segments that can define subsets of a media file, such as loops, for playback instead of the full media. Although the profile is referred to as a movement profile, one skilled in the relevant art will appreciate that the profile can correspond to the specification of media for playback, attributes associated with the playback, additional criteria that can be utilized for selecting media or media playback attributes, and timing information (start, stop, pause). Accordingly, in some embodiments, the operational parameters of the vehicle may not be indicative of movement of the vehicle and may not involve movement as part of the operational status. For example, in a ride share or taxi scenario, the movement profile may specify unique sounds or other media that are generated based on identification/recognition of a user via vision system sensor data in the vehicle 102.

At (3), the management component 104 begins the media playback. As described above, in embodiment, the management component 104 instantiates external speaker media application 108. Illustratively, the playback of the selected media via the external speaker system is controlled by an instantiated external speaker media application 108 that is separate from any internal speaker media application 112 that controls playback on the internal speaker systems 114. The external speaker media application 108 may be instantiated at the selection of media for playback. In some embodiments, the external speaker media application 108 may be pre-instantiated, such as based on the previous playback, and the instantiation step may be omitted.

At (4), the management component 108 obtains the vehicle operational parameters. Illustratively, the management component can request or otherwise access one or more operational parameters of the vehicle. The management component can select the operational parameters that are identified in the movement profile. Alternatively, the management component can receive a set of operational parameters and filter for the relevant operational parameters. As previously described, the operational parameters can include information provided by the components can include processed information in which a controller, logic unit, processor, and the like has processed sensor information. The operational information can illustratively include status information or state information for a variety of components, including, but not limited to, door status (e.g., open, closed, unlocked, locked), hood status, trunk status, compartment status, passenger status (e.g., present, not present, size, etc.), resource levels (e.g., power or fuel), temperature or environmental measures, and the like.

The operational status can further include generated additional information, such as a vision system that can utilize inputs from one or more camera sensors and provide outputs (e.g., processing of raw camera image data and the generation of outputs corresponding to the processing of the raw camera image information). The camera sensor may be the sensor component that is associated with vision systems for determining vehicle operational status, environmental status, or other information. In other embodiments, the camera sensors can be separate from the sensor components, such as for non-camera sensor components or vehicles having multiple camera sensors. In still another example, a control component can utilize additional information obtained from, or otherwise associated with, positioning systems, calendaring systems, or time-based systems.

In some embodiments, the movement profile can be attributed to identify and play media based on operational parameters of the vehicle. In one example, a door lock status (e.g., in an unlock or lock state) may be associated with media playback information that can identify particular media for playback, attributes/settings of the playback, additional criteria for controlling aspects of the playback (e.g., location information/proximity information), and the like. In another example, a vehicle horn status (depressed, non-depressed, rapid depression, series of depressions, etc.) may be associated with media playback information that can identify particular media for playback, attributes/settings of the playback, additional criteria for controlling aspects of the playback (e.g., location information, velocity information, proximity information, etc.), and the like. In still a further example, temperature sensors and vision systems for detecting the presence of various environmental conditions (e.g., rain, snow, ice, fog, etc.) may be associated with media playback information that can identify particular media for playback, attributes/settings of the playback, additional criteria for controlling aspects of the playback (e.g., location information/proximity information), and the like In still a further example, vision or another identification system or systems may be associated with media playback information that can identify particular media for playback (e.g., a favorite song of an identified passenger), attributes/settings of the playback, additional criteria for controlling aspects of the playback (e.g., location information/proximity information), and the like

At (5), the management component 104 processes the movement profile and can make specified adjustments. For example, the management component can specify a change in playback attributes, change timing information, and the like. The process can then repeat until the playback is terminated or the movement profile indicates that the playback should not continue.

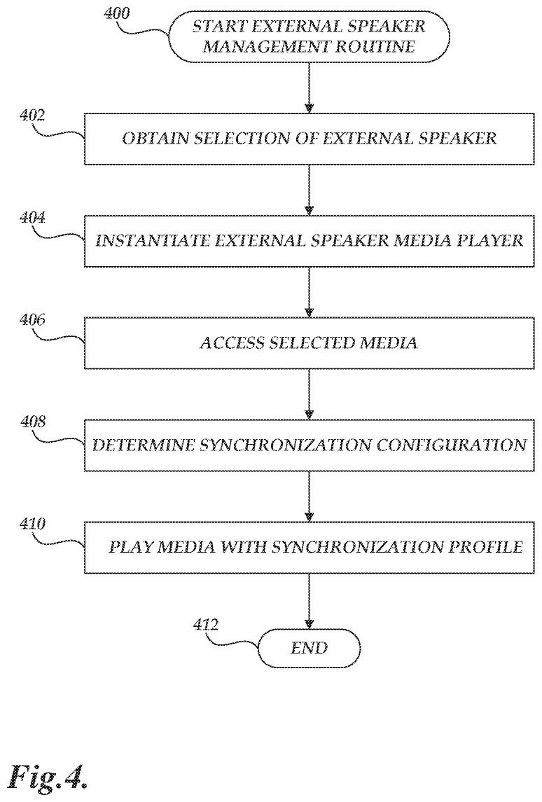

FIG. 4 illustrates a flow diagram of an illustrative process (as referenced in FIG. 2) implemented by the vehicle to process user requests for media playback. Routine 400 is illustratively implemented by the management component 104 of the vehicle 102. At block 402, a user selects a local media application for the playback of media (e.g., the generation of sound). Illustratively, a user may access a media application or control application 132 on a mobile device 130. The user can designate the media to be played and attributes of the playback including audio levels, speed, effects, and the like. In other embodiments, the user may access interfaces generated within the vehicle 102, such as a touch screen interface. In some embodiments, the selection of the local media application includes receipt of dynamically created media

In some embodiments, the user input can select or designate media that is stored in a variety of locations, such as network-based storage, local storage on a device, local storage on the vehicle, peer devices, etc. In other embodiments, the user input can include the generation of content to be played or rendered by the vehicle 102. For example, a user may be provided with functionality via the vehicle display or mobile device in which audio input can be captured via input device (e.g., microphone), processed and then provided as media for playback. In one embodiment, the capture of the audio input can correspond to a security/safety application in which the user content can be amplified, supplemented, or processed to notify bystanders of a safety issue, provide warnings to individual outside the vehicle, or a combination thereof. Additional external outputs, such as flashing of the headlights, etc., may also be selected. In another embodiment, the capture of audio input can correspond to music performance activities, such as singing (e.g., karaoke), playing of musical instruments, and the like.

In still other embodiments, the user can be presented with various situational input controls/objects in which a user can select a type of media without requiring the selection of a specific media file for playback. For example, a user can select a safety control or safety type that can result in the selection of predetermined sounds, audio tracks, etc. and associated attributes regarding playback. In another example, a user can select an emotional control or mood control that expresses a sentiment or desired result based on playback of media corresponding to the selected control. The user does not select media for playback but is electing to have specific media selected on behalf of the user. The selection can be dynamic, so the selected control may be a surprise to the user and may change, at least partially.

Additionally, at block 402 the user can select the playback of the media (e.g., audio) via the internal speaker system 114 (via the internal media application 112), the external speaker system 110 (via the external media application 108), or a combination thereof. In some embodiments, the user who does not select a media player to generate the playback can simply designate the desired audio output systems, such as the internal speaker system 114, external speaker system 110, or a combination. The user selections may be transmitted to the management component via a network connection, such as via an application programming interface (API) from the mobile device to the vehicle 102. In other embodiments, a user may utilize audio inputs (e.g., a microphone) to provide audio commands interpreted by the management component 104.

At block 404, the management component 104 instantiates external speaker media application 108. Illustratively, the playback of the selected media via the external speaker system is controlled by an instantiated external speaker media application 108 that is separate from any internal speaker media application 112 that controls playback on the internal speaker systems 114. The external speaker media application 108 may be instantiated at the selection of media for playback. In some embodiments, the external speaker media application 108 may be pre-instantiated, such as based on previous playback, and the instantiation step may be omitted.

At block 406, the instantiated external speaker media application 108 accesses the selected media, such as via direct access (e.g., physically connected media device or local media storage) or network access. In dynamic content is selected and has not been previously captured, the external speaker media application 108 may interface with a mobile device or vehicle input device to capture the dynamic content (e.g., spoken words). For example, in one embodiment, the dynamic content can include a karaoke type functionality in which a user interface may present a user with graphics/displays with lyrics or other cues to elicit audio (e.g., singing). In another embodiment, the dynamic content can include music generation in which a user may interface with a traditional instrument (e.g., a keyboard) or is presented a use interface corresponding to a musical instrument or music generating application.

At block 408, the management component 104 determines synchronization configuration. In some embodiments, the playback of media through the selected external speaker system may coordinate such that media playback may occur through the internal speaker system 114 as well. In one example, the internal speaker media application 112 and the external speaker media application 108 would then be synchronized as to the attributes of the playback (e.g., volume and playback speed) and timing (e.g., matching timing or offset). Each media application 108, 112 may continue to operate independently but can exchange information or be configured with information to facilitate concurrent playback. In another embodiment, multiple external speaker media applications 108 may also be synchronized such that a plurality of vehicles may implement a coordinated playback of media. Such coordination can include attributes of the playback, such as volume settings and timing. Additionally, the coordination can include the assignment of specific parts of the component to individual external speaker media application, such as for stereo effects, surround sound, etc.

At block 410, the external speaker media application generates the playback in accordance with the synchronization configuration. Routine 400 terminates at block 412.

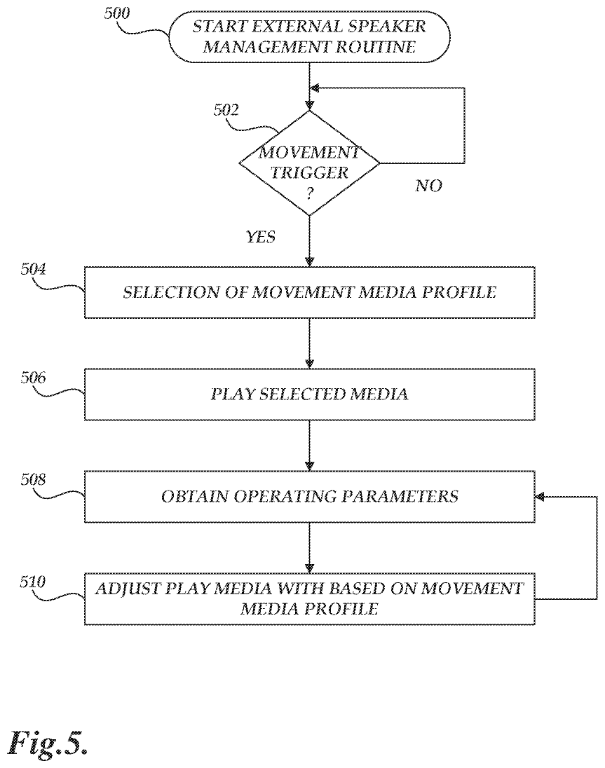

FIG. 5 illustrates a flow diagram of an illustrative process (as referenced in FIG. 3) implemented by a vehicle to playback media according to vehicle operational parameters. Routine 500 is illustrative implemented by management component 104.

At decision block 502, the management component 104 determines whether a trigger to cause the generation of media playback during the operation of the vehicle 102 has occurred. Illustratively, this can include a user-initiated selection, such as via an interface or mobile application 132 of a mobile device 130. In another example, the trigger may be based on geographic criteria (e.g., location of the vehicle), time criteria, environmental criteria (e.g., temperature), and the like.

At block 504, the management component 104 selects a movement profile. Illustratively, a movement profile corresponds to a specification of media for playback and control instructions for attributes of the media playback that are illustratively tied to operational parameters of the vehicle 102. In one example, the movement profile can specify one or more vehicle speed thresholds that indicate timing for the start of playback or stop of playback. In another example, the movement profile can specify volume settings and adjustment as a function of operational parameters, such as speed, temperature, wind presence and strength, vision systems, and the like. In still another example, the movement profile can further include media segment that can define subsets of a media file, such as loops, for playback instead of the full media. Although the profile is referred to as a movement profile, one skilled in the relevant art will appreciate that the profile can correspond to the specification of media for playback, attributes associated with the playback, additional criteria that can be utilized for selecting media or media playback attributes, and timing information (start, stop, pause). Accordingly, in some embodiments, the operational parameters of the vehicle may not be indicative of movement of the vehicle and may not involve movement as part of the operational status. For example, in a ride share or taxi scenario, the movement profile may specify unique sounds or other media that are generated based on identification/recognition of a user via vision system sensor data in a vehicle 102.

At block 506, the management component 104 selects a specified media and begins the media playback. As described above, in embodiment, the management component 104 instantiates external speaker media application 108. Illustratively, the playback of the selected media via the external speaker system is controlled by an instantiated external speaker media application 108 that is separate from any internal speaker media application 112 that control playback on the internal speaker systems 114. The external speaker media application 108 may be instantiated at the selection of media for playback. In some embodiments, the external speaker media application 108 may be pre-instantiated, such as based on previous playback, and the instantiation step may be omitted.

At block 508, the management component 108 obtains the vehicle operational parameters. Illustratively, the management component can request or otherwise access one or more operational parameters of the vehicle. The management component can select the operational parameters that are identified in the movement profile. Alternatively, the management component can receive a set of operational parameters and filter for the relevant operational parameters. As previously described, the operational parameters can include information provided by the components can include processed information in which a controller, logic unit, processor, and the like has processed sensor information. The operational information can illustratively include status information or state information for a variety of components, including, but not limited, door status (e.g., open, closed, unlocked, locked), hood status, trunk status, compartment status, passenger status (e.g., present, not present, size, etc.), resource levels (e.g., power or fuel), temperature or environmental measures, and the like.

The operational status can further include generated additional information, such as a vision system that can utilize inputs from one or more camera sensors and provide outputs (e.g., a processing of raw camera image data and the generation of outputs corresponding to the processing of the raw camera image information). The camera sensor may be the sensor component that is associated with vision systems for determining vehicle operational status, environmental status or other information. In other embodiments, the camera sensors can be separate from the sensor components, such as for non-camera sensor components or vehicles having multiple camera sensors. In still another example, a control component can utilize additional information obtained from, or otherwise associated with, positioning systems, calendaring systems, or time-based systems.

In some embodiments, the movement profile can be attributed to identify and play media based on operational parameters of the vehicle. In one example, a door lock status (e.g., in an unlock or lock state) may be associated with media playback information that can identify particular media for playback, attributes/settings of the playback, additional criteria for controlling aspects of the playback (e.g., location information/proximity information), and the like. In another example, a vehicle horn status (depressed, non-depressed, rapid depression, series of depressions, etc.) may be associated with media playback information that can identify particular media for playback, attributes/settings of the playback, additional criteria for controlling aspects of the playback (e g., location information, velocity information, proximity information, etc.), and the like. In still a further example, temperature sensors and vision systems for detecting the presence of various environmental conditions (e.g., rain, snow, ice, fog, etc.) may be associated with media playback information that can identify particular media for playback, attributes/settings of the playback, additional criteria for controlling aspects of the playback (e.g., location information/proximity information), and the like. In still a further example, vision or other identification system may be associated with media playback information that can identify particular media for playback (e.g., a favorite song of an identified passenger), attributes/settings of the playback, additional criteria for controlling aspects of the playback (e.g., location information/proximity information), and the like

At block 510, the management component 104 processes the movement profile and can make specified adjustments. For example, the management component can specify a change in playback attributes, change timing information, and the like. The process then can repeat until the playback is terminated or the movement profile indicates that the playback should not continue.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed air vent assembly. It is to be understood that the forms of disclosure herein shown and described are to be taken as representative embodiments. Equivalent elements, materials, processes, or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

What is claimed:

1. A system for managing media playback in vehicles, the system comprising one or more external computing devices associated with a processor and a memory for executing computer-executable instructions to implement a processing component, wherein the processing component is configured to:
obtain a selection of a local media application for playback of selected media;
cause instantiation of an external speaker media application, wherein the external media application is configured to generate output signals for an external speaker system of a vehicle;
access the selected media;
determine synchronization configuration associated with playback of the selected media; and
generate the playback in accordance with the synchronization configuration.

2. The system as recited in claim 1, wherein selection of the local media application corresponds to selection via a mobile device associated with a user.

3. The system as recited in claim 1, wherein selection of the local media application includes designation of media playback attributes.

4. The system as recited in claim 1, wherein the selection of the local media application includes receipt of dynamically created media.

5. The system as recited in claim 1, wherein the processing component accesses the selected media via a short-range radio communication channel.

6. The system as recited in claim 1, wherein the processing component accesses the selected media via a shared storage location with an internal media generation application.

7. The system as recited in claim 1, wherein the processing component access the selected media via a network connection.

8. The system as recited in claim 1, wherein the synchronization configuration corresponds to coordinated playback with at least one additional audio content generating component.

9. The system as recited in claim 8, wherein the at least one additional audio content generating component corresponds to an additional vehicle.

10. A computer-implemented method for generating media on an external speaker system associated with a vehicle, the external speaker system controlled by an external media application, the method comprising:
obtaining a selection of a local media application for playback of selected media;
accessing an external speaker media application, wherein the external media application is configured to generate output signals for the external speaker system of a vehicle; and
generating the playback of selected media in accordance with synchronization configuration.

11. The computer-implemented method as recited in claim 10, wherein selection of the local media application corresponds to selection via a mobile device associated with a user.

12. The computer-implemented method as recited in claim 10, wherein selection of the local media application includes designation of media playback attributes.

13. The computer-implemented method as recited in claim 10, wherein the selection of the local media application includes receipt of dynamically created media.

14. The computer-implemented method as recited in claim 10 further comprising accessing selected media.

15. The computer-implemented method as recited in claim 14, wherein accessing the media include accessing the selected media via a short-range radio communication channel.

16. The computer-implemented method as recited in claim 14, wherein accessing the media include accessing the selected media via a shared storage location with an internal media generation application.

17. The computer-implemented method as recited in claim 14, wherein accessing the media include via a network connection.

18. The computer-implemented method as recited in claim 10, wherein the synchronization configuration corresponds to coordinated playback with at least one additional audio content generating component.

19. A computer-implemented method for generating media on an external speaker system associated with a vehicle, the external speaker system controlled by an external media application, the method comprising:
accessing an external speaker media application responsive to a selected local media application, wherein the external media application is configured to generate output signals for the external speaker system of a vehicle; and
generating a playback of selected media in accordance with synchronization configuration.

20. The computer-implemented method as recited in claim 19, wherein selection of the local media application corresponds to selection via a mobile device associated with a user.

21. The computer-implemented method as recited in claim 19, wherein selection of the local media application includes designation of media playback attributes.

22. The computer-implemented method as recited in claim 19, wherein the selection of the local media application includes receipt of dynamically created media.

23. The computer-implemented method as recited in claim 19 further comprising accessing selected media.

24. The computer-implemented method as recited in claim 23, wherein accessing the media include accessing the selected media via at least one of a short-range radio communication channel, a shared storage location with an internal media generation application or a network connection.

25. The computer-implemented method as recited in claim 19, wherein the synchronization configuration corresponds to coordinated playback with at least one additional audio content generating component.
